(19) United States
(12) Patent Application Publication
(10) Pub. No.: US 2009/0214398 A1
(43) Pub. Date: Aug. 27, 2009

(54) WASTE LIQUID PROCESSING DEVICE

(75) Inventors: Shinji HIRATA, Matsumoto-shi (JP); Toshio KUMAGAI, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/393,549

(22) Filed: Feb. 26, 2009

(30) Foreign Application Priority Data
Feb. 27, 2008 (JP) 2008-045615

(51) Int. Cl. B01J 19/12

(52) U.S. Cl. 422/186.3

(57) ABSTRACT

A waste liquid processing device includes: a waste liquid tank to which a liquid to be hardened by radiation of an energy ray is introduced as a waste liquid; a radiation unit which radiates the energy ray for hardening the waste liquid to the waste liquid introduced to the waste liquid tank; and a buffer tank which temporarily stores the waste liquid in a non-hardened state between a waste liquid discharging source and the waste liquid tank and which intermittently introduces the stored waste liquid to the waste liquid tank.

### CROSS-REFERENCE TO RELATED APPLICATION

The entire disclosure of Japanese Patent Application No. 2008-045615, filed Feb. 27, 2008 is expressly incorporated by reference herein.

### BACKGROUND

1. Technical Field

The present invention relates to a waste liquid processing device capable of processing an energy ray hardening type liquid such as energy ray hardening type ink which is hardened by radiation of an energy ray such as an ultraviolet ray (UV), and particularly to a waste liquid processing device applicable to a liquid ejecting apparatus such as an ink jet printing apparatus ejecting ink droplets from nozzles in accordance with print data to form dots on a print medium.

2. Related Art

As a liquid ejecting apparatus ejecting a liquid on a target, there is known an ink jet printing apparatus which ejects ink on a print sheet to perform printing. A print head of the ink jet printing apparatus ejects ink pressured in a pressure generating chamber as ink droplets on a print sheet from nozzles to perform the printing. Therefore, since ejection may fail due to an increase in ink viscosity caused by solvent evaporation from the nozzles, ink solidification, dust attachment, and bubble mixture, the print head has a problem that print failure is caused.

In order to solve this problem, the ink jet printing apparatus is provided with a capping unit which seals nozzle openings of the print head in a non-printing state and a wiping unit which cleans a nozzle-formed surface, if necessary. The capping unit functions as a cover which prevents dryness of ink of the nozzle openings. Moreover, when the nozzle openings are clogged, the capping unit also has a function of solving the clogging of the nozzle openings by sealing the nozzle-formed surface and sucking and discharging the ink from the nozzle openings by a negative pressure generated from a sucking pump.

A process of forcedly sucking and discharging ink to solve the clogging in the print head is called a cleaning process. The cleaning process is performed, when printing is resumed after a long pause of a printing apparatus or when a user recognizes a failure in printing and operates a cleaning switch, for example. After the ink is ejected from the print head, a process of wiping out the nozzle-formed surface of the print head is also performed by the wiping unit formed of an elastic plate made of rubber.

Along with the cleaning process, a waste liquid which comes from the print head and is stored in the capping unit is configured to be removed to a waste liquid tank by drive of the sucking pump. A waste liquid absorbing member generally formed of a porous material is received in the waste liquid tank and the waste liquid absorbing member absorbs the liquid waste.

On the other hand, as one of ink jet printing methods, there is known a UV ink jet method. The UV ink jet method is a printing method of hardening energy ray hardening ink by attaching energy ray hardening ink, which is hardened by radiation of an energy ray such as an ultraviolet (UV) ray, on a print medium and then hardening the energy ray hardening ink by radiation of the energy ray on the print medium.

As the UV ink jet printing apparatus, there was suggested an apparatus capable of introducing waste ink absorbed by operation of the cleaning process to a waste ink tray as a waste liquid container and hardening the waste ink introduced to the waste liquid container by radiation of an ultraviolet ray (see JP-A-2003-211705).

In the apparatus disclosed in JP-A-2003-211705, however, since the hardened waste ink is not transparent, ink close to a liquid surface is swiftly hardened at the time of radiating an ultraviolet ray on the liquid surface from the upper side of the waste liquid container into which the waste ink is introduced. However, since it is difficult for the ultraviolet ray to reach a portion closer to the bottom of the waste liquid container, some waste ink may not be hardened. In particular, when a large amount of waste ink is introduced to the waste liquid container at once, there is a high possibility that only the waste ink near the liquid surface is hardened and waste ink which is not hardened may remain in the inside.

It is known that the ultraviolet ray hardening type liquid contains many substances giving a stimulus to skins and has strong a stimulating smell. Moreover, it is also known that the ultraviolet ray hardening type liquid has a bad influence on a human body when it directly touches skins and a work environment in the non-hardened state of the ultraviolet ray hardening type liquid is bad due to the stimulating smell. However, when the ultraviolet ray hardening type liquid is hardened, it is known that the ultraviolet ray hardening type liquid is harmless and the stimulating smell is suppressed. In view of such a circumstance, when the ultraviolet ray hardening type waste liquid remains not to be hardened, as in JP-A-2003-211705, a problem may occur in that safety or comfortableness of a work environment cannot be ensured when the waste liquid container is collected and burned up. Moreover, when the waste liquid which has not been hardened remains at the time of destroying the waste liquid container, contact of the non-hardened waste liquid with other chemicals causes a reaction and thus a danger of heating or firing may occurs.

### SUMMARY

An advantage of some aspects of the invention is that it provides a waste liquid processing device capable of processing a waste liquid safely and easily by collecting the waste liquid in a solidified state.

According to an aspect of the invention, there is provided a waste liquid processing device including: a waste liquid tank to which a liquid to be hardened by radiation of an energy ray is introduced as a waste liquid; a radiation unit which radiates the energy ray for hardening the waste liquid to the waste liquid introduced to the waste liquid tank; and a buffer tank which temporarily stores the waste liquid in a non-hardened state between a waste liquid discharging source and the waste liquid tank and which intermittently introduces the stored waste liquid to the waste liquid tank.

In the waste liquid processing device according to this aspect of the invention, by intermittently introducing the non-hardened waste liquid from the buffer tank to the waste liquid tank, the energy ray is radiated until the one-time amount of waste liquid introduced to the waste liquid tank at one time and the waste liquid is hardened up to the deep part without stain. Subsequently, the waste liquid is again introduced from the buffer tank. When these operations are repeated, the waste liquid in the waste liquid tank is completely hardened without the non-hardened waste liquid. Therefore, it is possible to ensure safety or comfortableness in collection and disposal of the waste liquid tank. Moreover, it is possible to eliminate a danger of heating or firing caused due to contact of the non-hardened waste liquid with other chemicals or the like at the time of destroying the waste liquid tank.

In the waste liquid processing device, a one-time amount of waste liquid to be introduced from the buffer tank to the waste liquid tank may be set such that the waste liquid introduced to the waste liquid tank becomes a liquid film having a thickness equal to or less than a predetermined thickness in the waste liquid tank. Since the waste liquid introduced from the buffer tank to the waste liquid tank at one time becomes the liquid film having the thickness equal to or less than the predetermined thickness and the energy ray from the radiation unit sufficiently reaches a deep part of the liquid film, the non-hardened waste liquid rarely remains. Therefore, it is possible to ensure safety or comfortableness in collection and disposal of the waste liquid tank.

In the waste liquid processing device, the one-time amount of waste liquid to be introduced may be set such that the energy ray of the radiation unit reaches a deep part of the liquid film when the introduced waste liquid becomes the liquid film. Since the waste liquid introduced from the buffer tank to the waste liquid tank at one time becomes the liquid film and the energy ray from the radiation unit sufficiently reaches the deep part of the liquid film, the non-hardened waste liquid rarely remains. Therefore, it is possible to ensure safety or comfortableness in collection and disposal of the waste liquid tank.

In the waste liquid processing device, the radiation of the radiation unit may be interrupted when the waste liquid is introduced from the buffer tank to the waste liquid tank, and the radiation of the radiation unit may be resumed after predetermined time in which the introduced waste liquid becomes the liquid film. The energy ray is not radiated at the time of introducing the waste liquid, and it is sufficiently waited until the waste liquid introduced from the buffer tank to the waste liquid tank at one time becomes the liquid film having a uniform thickness. Thereafter, by resuming the radiation of the energy ray, it is possible to completely perform a hardening process in a short time without the hardened stain. Moreover, it is possible to prevent the hardened waste liquid from being partially swollen and effectively use the inner space of the waste liquid tank as a space for receiving the hardened waste liquid.

In the waste liquid processing device, the buffer tank may include an introduction port which has a small diameter and intermittently introduces the stored waste liquid to the waste liquid tank. With such simple configuration, it is possible to completely harden the waste liquid in the waste liquid tank. In addition, it is possible to ensure safety or comfortableness in collection and disposal of the waste liquid tank.

In the waste liquid processing device, the buffer tank may include a pump which intermittently introduces the stored waste liquid to the waste liquid tank. It is possible to easily control the one-time amount of waste liquid to be introduced in accordance with various conditions and set an amount of waste liquid to be introduced in accordance with a changed condition of the hardened state. In addition, it is possible to completely harden the waste liquid in the waste liquid tank under any condition. It is possible to ensure safety or comfortableness in collection and disposal of the waste liquid tank.

In the waste liquid processing device, the buffer tank may include a pressure chamber which collects the waste liquid to be stored, an introduction port which introduces the waste liquid from the pressure chamber to the waste liquid tank, and a pressure generating unit which intermittently generates pressure in the pressure chamber to intermittently introduce the waste liquid in the pressure chamber from the introduction port to the waste liquid tank. It is possible to easily control the one-time amount of waste liquid to be introduced in accordance with various conditions and set an amount of waste liquid to be introduced in accordance with a changed condition of the hardened state. In addition, it is possible to completely harden the waste liquid in the waste liquid tank under any condition. It is possible to ensure safety or comfortableness in collection and disposal of the waste liquid tank.

In the waste liquid processing device, the buffer tank may include an introduction port which introduces the waste liquid at a predetermined height from the buffer tank to the waste liquid tank and a hydraulic head pressure changing unit which intermittently introduces the waste liquid in the buffer tank from the introduction port to the waste liquid tank by intermittently changing hydraulic head pressure of the waste liquid stored in the waste liquid tank with respect to the introduction port. It is possible to easily control the one-time amount of waste liquid to be introduced in accordance with various conditions and set an amount of waste liquid to be introduced in accordance with a changed condition of the hardened state. In addition, it is possible to completely harden the waste liquid in the waste liquid tank under any condition. It is possible to ensure safety or comfortableness in collection and disposal of the waste liquid tank.

### BRIEF DESCRIPTION OF THE DRAWINGS

The invention will be described with reference to the accompanying drawings, wherein like numbers reference like elements.

FIG. 1 is a diagram illustrating an overall configuration of a printing apparatus according to the invention.

FIGS. 2A and 2B are sectional views illustrating the configuration of a waste liquid processing device according to an embodiment.

FIG. 3 is a diagram illustrating a waste liquid processing device according to a second embodiment.

FIGS. 4A to 4C are diagrams illustrating a waste liquid processing device according to a third embodiment.

FIGS. 5A and 5B are diagrams illustrating a waste liquid processing device according to a fourth embodiment.

### DESCRIPTION OF EXEMPLARY EMBODIMENTS

Hereinafter, exemplary embodiments of the invention will be described in detail.

A waste liquid processing device applied to an ink jet printing apparatus as a liquid ejecting apparatus ejecting a liquid will be described below with reference to the drawings according to an embodiment of the invention.

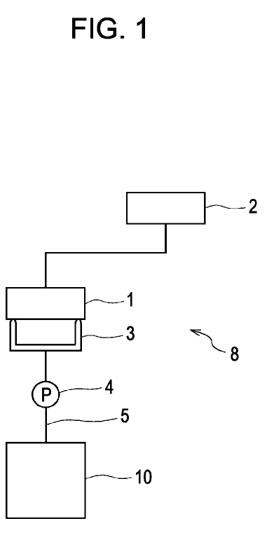

FIG. 1 is a diagram illustrating the configuration of main constituent elements of the ink jet printing apparatus as the liquid ejecting apparatus according to the invention.

In FIG. 1, Reference Numeral 1 denotes an ejection head which receives ink supplied from an ink cartridge 2 as an ink tank and ejects ink droplets on a target (not shown) from nozzles to perform printing. Reference Numeral 3 denotes a capping unit which is disposed outside a print area. The capping unit 3 is connected to a suction pump 4 which gives negative pressure to the inside space of the capping unit 3.

The capping unit 3 functions as a cover which seals a nozzle-formed surface of the ejection head 1 during a pause period of a printing apparatus to prevent dryness of the nozzles. The capping unit 3 also functions as a cleaning unit which sucks and discharges ink from the ejection head 1 by applying the negative pressure from the suction pump 4 to the ejection head 1.

With such a configuration, it is possible to maintain an ejection characteristic of the ejection head 1 by forcedly sucking and discharging the ink by suction of the suction pump 4 after the nozzle-formed surface of the ejection head 1 is capped with the capping unit 3, and by sucking and discharging ink having increased viscosity and bubbles in the ejection head 1, when the ink cartridge 2 is exchanged, the nozzles of the ejection head 1 are clogged, or the liquid ejecting apparatus starts to be activated after non-use of the liquid ejecting apparatus for a long time.

The ink discharged from an ink discharging passage 5 by suction of the suction pump 4 is introduced into a waste liquid processing device 10 according to the invention to be hardened in the waste liquid process device 10.

That is, the ink cartridge 2, the ejection head 1, the capping unit 3, the suction pump 4, and the like function as a waste liquid discharging source 8. Waste ink discharged from the waste liquid discharging source 8 is configured to be discharged from the ink discharging passage 5 and supplied to the waste liquid processing device 10.

The waste liquid discharging source 8 is not limited to the above-described configuration. For example, the waste liquid discharging source 8 may have a configuration capable of discharging the waste liquid, such as in an ink receiving unit which receives the ink ejected by a flushing process of allowing the ejection head 1 to forcedly eject ink by supplying an ink ejecting signal not associated with a recording process at predetermined timing upon turning on a liquid ejecting apparatus to start use of the liquid ejecting apparatus or during performing a recording process.

In FIG. 1, just one ink cartridge 2 is illustrated, but a liquid ejecting apparatus ejecting plural kinds of a liquid has plural ink cartridges 2 according to kinds of a liquid. In addition, a waste liquid in which the plural kinds of a liquid are mixed is supplied to the waste liquid processing device 10.

In this embodiment, an energy ray hardening type liquid such as energy ray hardening ink, which is hardened by radiation of an energy ray such as an ultraviolet (UV) ray as a representative example, is used as the ink. For example, ultraviolet ray hardening ink has components such as an ultraviolet hardening resin (in the range of 5% to 10%), a colorant (in the range of 5% to 10%), an additive (about 20%) used for stable printing in an ink jet printing apparatus, water (in the range of 60% to 70%), and the like.

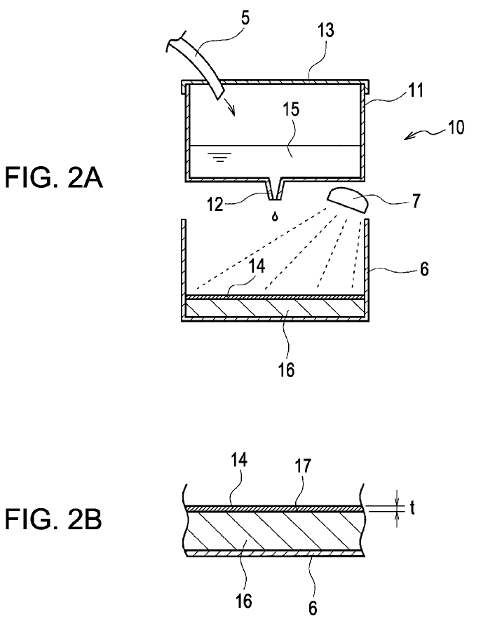

FIGS. 2A and 2B are diagrams illustrating the configuration of the waste liquid processing device 10.

The waste liquid processing device 10 includes a waste liquid tank 6 to which a liquid to be hardened by radiation of the energy ray is introduced as a waste liquid, a radiation unit 7 which radiates the energy ray for hardening the waste liquid introduced to the waste liquid tank 6, and a buffer tank 11 which stores the waste liquid in a non-hardened state between the waste liquid discharging source 8 and the waste liquid tank 6 and which intermittently introduces a non-hardened waste liquid 15 to the waste liquid tank 6.

In this embodiment, the buffer tank 11 includes an introduction port 12 which has a small diameter and intermittently introduces the non-hardened waste liquid 15 to the waste liquid tank 6. In addition, the buffer tank 11 has a cover 13 so that the non-hardened waste liquid 15 supplied in the buffer tank 11 is not hardened by light.

The waste liquid tank 6 includes the radiation unit 7 which radiates the energy ray to the waste liquid introduced to the waste liquid tank 6. The radiation unit 7 radiates an ultraviolet ray (UV ray) as the energy ray. Specifically, an LED or the like radiating light in the ultraviolet region, for example, can be used. In this embodiment, the radiation unit 7 is configured to radiate the entire surface of the bottom portion of the waste liquid tank 6 and radiate the energy ray to the waste liquid spread to form a liquid film 14 on the entire surface of the bottom portion.

In this embodiment, the introduction port 12 is provided in the bottom portion of the buffer tank 11 so that the non-hardened waste liquid 15 supplied in the buffer tank 11 falls by the gravity to be introduced to the waste liquid tank 6. In addition, the opening of the introduction port 12 is configured to have an opening size such that the non-hardened waste liquid 15 becomes a liquid droplet to intermittently fall.

An one-time amount of waste liquid to be introduced from the buffer tank 11 to the waste liquid tank 6 is set such that the non-hardened waste liquid 15 introduced to the waste liquid tank 6 becomes the liquid film 14 having a thickness equal to or less than a predetermined thickness in the waste liquid tank 6. In addition, the non-hardened waste liquid 15 introduced to the waste liquid tank 6 becomes the liquid film 14 and a hardened waste liquid 16 after the radiation of the energy ray from the radiation unit 7. When a new non-hardened waste liquid 15 is introduced from the introduction portion 12 of the buffer tank 11 onto the hardened waste liquid 16, the new non-hardened waste liquid 15 becomes the liquid film 14 and is hardened. Upon repeatedly performing these operations, the hardened waste liquid 16 is collected in the waste liquid tank 6.

The one-time amount of waste liquid to be introduced is set such that the energy ray from the radiation unit 7 reaches a deep part of the liquid film 17 when the non-hardened waste liquid 15 which has been introduced becomes the liquid film 14. That is, if a thickness t formed when the non-hardened waste liquid 15 introduced to the waste liquid tank 6 becomes the liquid film 14 is too thick, the energy ray from the radiation unit 7 does not reach the deep part 17 which is an interface between the non-hardened waste liquid 14 and the bottom portion of the liquid tank below the non-hardened waste liquid 14 or an interface between the non-hardened waste liquid 14 and the hardened waste liquid 16. Therefore, the non-hardened waste liquid may easily remain. For this reason, the opening size of the introduction port 12 is set so that the one-time amount of waste liquid to be introduced becomes the amount described above.

It is preferable to control the radiation so that the radiation of the energy ray from the radiation unit 7 is interrupted when the non-hardened waste liquid 15 is introduced from the buffer tank 11 to the waste liquid tank 6, and the radiation of the energy ray from the radiation unit 7 is resumed after predetermined time in which the introduced non-hardened waste liquid 15 becomes the liquid film 14 in the waste liquid tank 6. Non-radiation time of the energy ray at the time of introducing the non-hardened waste liquid 15 can be appropriately set in accordance with a kind or viscosity of a liquid, the size or shape of the waste liquid tank 6, and the like. In addition, radiation time of the energy ray can be appropriately set in accordance with a kind of a liquid, a type or illumination of the radiation unit 7, the thickness of the liquid film 14, and the like.

The waste liquid processing device 10 described above can perform a waste liquid processing in the following way, for example.

That is, when the ink cartridge 2 is exchanged in the ink jet printing apparatus, or the nozzles of the ejection head 1 are clogged, or the liquid ejecting apparatus starts to be activated after the liquid ejecting apparatus is not used for a long time, the ink is forcedly sucked and discharged by sucking the nozzle-formed surface by the suction pump 4 at predetermined suction timing after the nozzle-formed surface of the ejection head 1 is capped with the capping unit 3.

The sucked ink is supplied from the ink discharging passage 5 to the buffer tank 11 and temporarily stored in a non-hardened state. In addition, the non-hardened waste liquid 15 which becomes liquid droplets is intermittently introduced from the buffer tank 11 to the waste liquid tank 6. The non-hardened waste liquid 15 introduced to the waste liquid tank 6 becomes the liquid film 14 having the thickness equal to or less than the predetermined thickness in the waste liquid tank 6, is radiated with the energy ray from the radiation unit 7, and hardened, and become the hardened waste liquid 16. The non-hardened waste liquid 15 is newly introduced on the hardened waste liquid 16 from the introduction port 12 of the buffer tank 11, becomes the liquid film 14, and radiated with the energy ray, additionally hardened. When these operations are repeated, the hardened waste liquid 16 is collected to the waste liquid tank 6.

In this way, in the waste liquid processing device 10 according to this embodiment, when the waste liquid introduced to the waste liquid tank 6 at one time is spread in the waste liquid tank 6 and the thickness of the waste liquid becomes thin by intermittently introducing the non-hardened waste liquid 15 from the buffer tank 11 to the waste liquid tank 6, the energy ray is radiated and the waste liquid is hardened up to the deep part 17 without stain. Subsequently, the waste liquid is again introduced from the buffer tank 11. By repeatedly performing these operations, the waste liquid in the waste liquid tank 6 is completely hardened without non-hardened waste liquid. Therefore, it is possible to ensure safety or comfortableness in collection and disposal of the waste liquid tank 6. Moreover, it is possible to eliminate a danger of heating or firing caused due to contact of the non-hardened waste liquid 15 with other chemicals or the like at the time of destroying the waste liquid tank 6.

Since the one-time amount of waste liquid to be introduced from the buffer tank 11 to the waste liquid tank 6 is set such that the waste liquid introduced to the waste liquid tank 6 becomes the liquid film 14 having the thickness equal to or less than the predetermined thickness in the waste liquid tank 6, the waste liquid introduced from the buffer tank 11 to the waste liquid tank 6 at one time becomes the liquid film 14 having the thickness equal to or less than the predetermined thickness and the energy ray from the radiation unit 7 sufficiently reaches the deep part 17 of the liquid film 14. Therefore, the non-hardened waste liquid does not remain and it is possible to ensure safety or comfortableness in collection and disposal of the waste liquid tank 6.

Moreover, since the one-time amount of waste liquid to be introduced is set such that the energy ray of the radiation unit 7 reaches the deep part 17 when the introduced waste liquid becomes the liquid film 14, the waste liquid introduced from the buffer tank 11 to the waste tank 6 at one time becomes the liquid film 14. Therefore, since the energy ray from the radiation unit 7 sufficiently reaches the deep part 17, the non-hardened waste liquid does not remain. In addition, it is possible to ensure safety or comfortableness in collection and disposal of the waste liquid tank 6.

The radiation from the radiation unit 7 is interrupted when the waste liquid is introduced from the buffer tank 11 to the waste liquid tank 6. The energy ray is configured not to be radiated at the time of introducing the waste liquid in order to resume the radiation of the radiation unit 7 after the predetermined time in which the introduced waste liquid becomes the liquid film 14 in the waste liquid tank 6. It is sufficiently waited until the waste liquid introduced from the buffer tank 11 to the waste liquid tank 6 at one time becomes the liquid film 14 having a uniform thickness. Thereafter, by resuming the radiation of the energy ray, the hardening process can be completely performed in a short time without the hardened stain. Therefore, it is possible to prevent the hardened waste liquid 16 from being partially swollen and effectively use the inner space of the waste liquid tank 6 as a space for receiving the hardened waste liquid 16.

Since the buffer tank 11 includes the introduction port 12 which has the small diameter and intermittently introduces the stored waste liquid to the waste liquid tank 6, it is possible to completely harden the waste liquid in the waste liquid tank 6 with the simple configuration. In addition, it is possible to ensure safety or comfortableness in collection and disposal of the waste liquid tank 6.

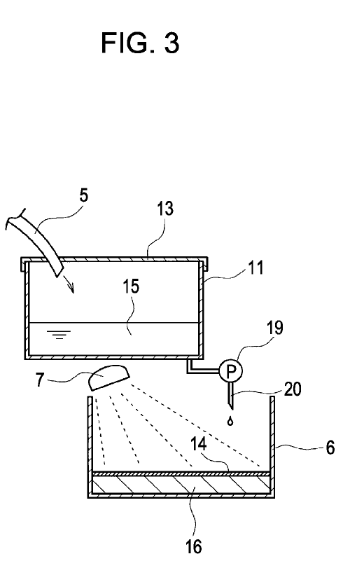

FIG. 3 is a diagram illustrating a waste liquid processing device 10 according to a second embodiment of the invention.

In this embodiment, the buffer tank 11 includes a pump 19 which intermittently introduces the non-hardened waste liquid 15 to the waste liquid tank 6 and an introduction pipe 20 which introduces the non-hardened waste liquid 15 to the waste liquid tank 6 by the pump 19.

In this embodiment, a one-time amount of waste liquid to be introduced from the buffer tank 11 to the waste tank 6 by the pump 19 is set such that the waste liquid introduced to the waste liquid tank 6 becomes the liquid film 14 having a thickness equal to or less than a predetermined thickness in the waste liquid tank 6. In addition, the one-time amount of waste liquid to be introduced is set such that the energy ray from the radiation unit 7 reaches a deep part of the liquid film when the introduced waste liquid becomes the liquid film 14. Other configuration is the same as that in the first embodiment and the same reference numerals are given to the same constituent elements.

According to this embodiment, it is possible to easily control the one-time amount of waste liquid to be introduced by the pump 19 according to various conditions and set an amount of waste liquid to be introduced in accordance with a changed condition of the hardened state. In addition, it is possible to completely harden the waste liquid in the waste liquid tank 6 under any condition. It is possible to ensure safety or comfortableness in collection and disposal of the waste liquid tank 6. Other advantages the same as those in the first embodiment are obtained.

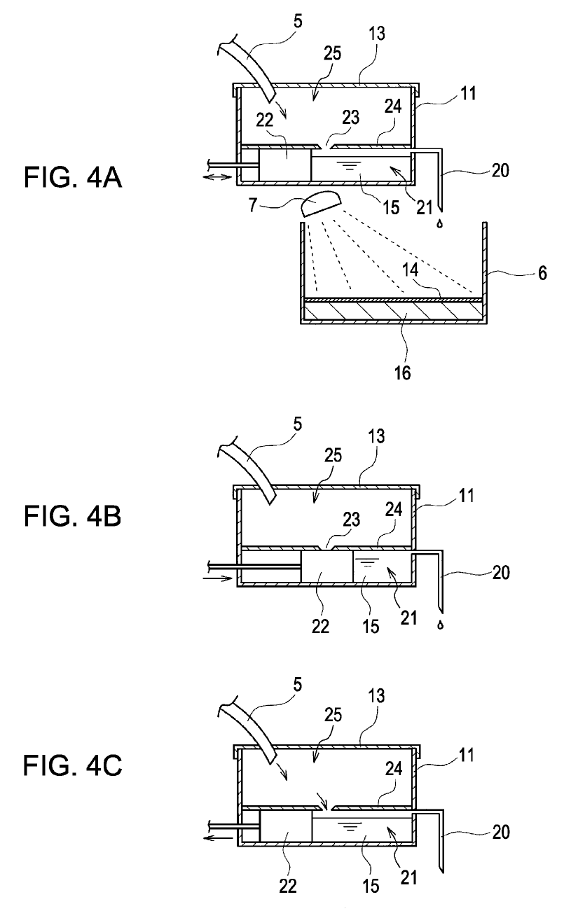

FIGS. 4A to 4C are diagrams illustrating a waste liquid processing device 10 according to a third embodiment of the invention.

In this embodiment, the buffer tank 11 includes a pressure chamber 21 which collects a waste liquid to be stored, an introduction pipe 20 having an introduction port introducing the waste liquid from the pressure chamber 21 to the waste liquid tank 6, and a pressure generating unit which intermittently generates pressure in the pressure chamber 21 and intermittently introduces the waste liquid in the pressure chamber 21 from the introduction port to the waste liquid tank 6.

More specifically, in the buffer tank 11, an upper waste liquid receiving space 25 and a lower space are separated by a separation member 24 having a waste liquid supply port 23 in the substantially middle portion. A piston 22 as a pressure generating unit is received in the lower space so as to slide right and left and a space formed on a side of a front end surface of the piston 22 is formed as a pressure chamber 21. In addition, the introduction pipe 20 is provided so as to communicate with the pressure chamber 21.

When the piston 22 slides right and left in the lower space, the waste liquid supply port 23 is opened and closed and simultaneously pressure is generated in the pressure chamber 21. That is, the waste liquid supply port 23 is opened when the piston 22 is retreated and the non-hardened waste liquid 15 received to the waste liquid receiving space 25 is configured to be supplied to the pressure chamber 21. In addition, when the piston 22 is advanced, the waste liquid supply port 23 is closed by the piston 22 and simultaneously a pressurizing force is applied to the waste liquid in the pressure chamber 21.

By advancing the piston 22 at predetermined timing at which the waste liquid is introduced from the buffer tank 11 to the waste liquid tank 6, the waste liquid is introduced from the introduction pipe 20 to the waste liquid tank 6. When a predetermined amount of waste liquid is completely introduced, the piston 22 is retreated to stop introducing the waste liquid and the non-hardened waste liquid 15 received to the waste liquid receiving space 25 is supplied to the pressure chamber 21.

In this embodiment, a one-time amount of waste liquid to be introduced from the buffer tank 11 to the waste liquid tank 6 by the pressure generating unit is set such that the waste liquid introduced to the waste liquid tank 6 becomes the liquid film 14 having a thickness equal to or less than a predetermined thickness in the waste liquid tank 6. In addition, the one-time amount of waste liquid to be introduced is set such that the energy ray from the radiation unit 7 reaches the deep part 17 of the liquid film when the introduced waste liquid becomes the liquid film 14. Other configuration is the same as that in the first embodiment and the same reference numerals are given to the same constituent elements.

According to this embodiment, it is possible to easily control the one-time amount of waste liquid to be introduced by the pressure generating unit in accordance with various conditions and set an amount of waste liquid to be introduced in accordance with a changed condition of the hardened state. In addition, it is possible to completely harden the waste liquid in the waste liquid tank 6 under any condition. It is possible to ensure safety or comfortableness in collection and disposal of the waste liquid tank 6. Other advantages the same as those in the first embodiment are obtained.

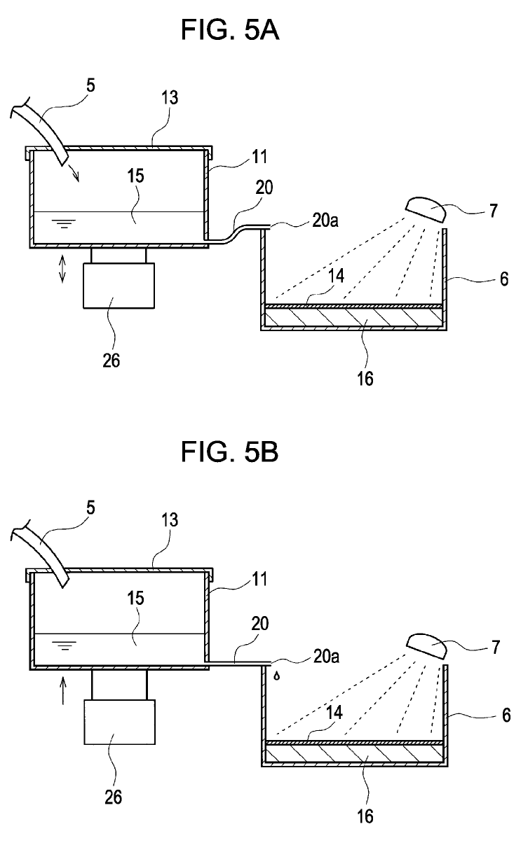

FIGS. 5A and 5B are diagram illustrating a waste liquid processing device 10 according to a fourth embodiment of the invention.

In this embodiment, the buffer tank 11 includes an introduction pipe 20 which has an introduction port 20a introducing a waste liquid at a predetermined height from the buffer tank 11 to the waste liquid tank 6 and a hydraulic head pressure changing unit which intermittently introduces the waste liquid in the buffer tank 11 from the introduction port 20a to the waste liquid tank 6 by intermittently changing hydraulic head pressure of the waste liquid stored in the waste liquid tank 6 with respect to the introduction port 20a.

More specifically, the buffer tank 11 is configured to be moved up and down by an elevation unit 26 as the hydraulic head pressure changing unit. The introduction pipe 20 is formed of a flexible material and the introduction port 20a a front end is fixed to an upper end portion of the waste liquid tank 6 at a predetermined height. The introduction pipe 20 is deformed in accordance with elevation movement of the buffer tank 11.

The elevation unit 26 moves up the buffer tank 11 at predetermined timing at which the waste liquid is introduced from the buffer tank 11 to the waste liquid tank 6 and introduces the waste liquid from the introduction port 20a to the waste liquid tank 6 by increasing the hydraulic head pressure of the non-hardened waste liquid 15 in the buffer tank 11 with respect to the introduction port 20a. When a predetermined amount of waste liquid is completely introduced, the elevation unit 26 moves down the buffer tank 11 and decreases the hydraulic head pressure to stop introducing the waste liquid.

In this embodiment, the one-time amount of waste liquid to be induced from the buffer tank 11 to the waste liquid tank 6 by the hydraulic head pressure changing unit is set such that the waste liquid introduced to the waste liquid tank 6 becomes the liquid film 14 having a thickness equal to or less than the predetermined thickness in the waste liquid tank 6. In addition, the one-time amount of waste liquid to be introduced is set such that the energy ray from the radiation unit 7 reaches the deep part 17 of the liquid film when the introduced waste liquid becomes the liquid film 14. Other configuration is the same as that in the first embodiment and the same reference numerals are given to the same constituent elements.

According to this embodiment, it is possible to easily control the one-time amount of waste liquid to be introduced by the hydraulic head pressure changing unit in accordance with various conditions and set an amount of waste liquid to be introduced in accordance with a changed condition of the hardened state. In addition, it is possible to completely harden the waste liquid in the waste liquid tank 6 under any condition. It is possible to ensure safety or comfortableness in collection and disposal of the waste liquid tank 6. Other advantages the same as those in the first embodiment are obtained.

In the above-described embodiments, the LED as the radiation unit 7 emitting light in the ultraviolet region has been described as an example, but the invention is not limited thereto. For example, as the radiation unit 7, various energy ray radiation units such as a metal halide lamp, a xenon lamp, a carbon-arc lamp, a chemical lamp, a low-pressure mercury vapor lamp, and a high-pressure mercury vapor lamp can be used.

In the above-described embodiments, the ejection head 1 is a pressure generating element which is driving element ejecting a liquid and is applicable to a liquid ejecting apparatus using a piezoelectric vibrator and a liquid ejecting apparatus which uses a heating element.

A representative example of the liquid ejecting apparatus is an ink jet printing apparatus including an ink jet print head for recording an image, as described above. However, the invention is applicable to various liquid ejecting apparatuses such as an apparatus including a color material ejecting head used to manufacture a color filter such as a liquid crystal display, an apparatus including an electrode material (conductive paste) used to form electrodes such as in an organic EL display or a field emission display (FED), an apparatus including a bio-organism ejecting head used to manufacture a bio chip, and an apparatus including a sample ejecting head as a precise pipette.

What is claimed is:

1. A waste liquid processing device comprising:
a waste liquid tank to which a liquid to be hardened by radiation of an energy ray is introduced as a waste liquid;
a radiation unit which radiates the energy ray for hardening the waste liquid to the waste liquid introduced to the waste liquid tank; and
a buffer tank which temporarily stores the waste liquid in a non-hardened state between a waste liquid discharging source and the waste liquid tank and which introduces the stored waste liquid to the waste liquid tank.

2. The waste liquid processing device according to claim 1, wherein a one-time amount of waste liquid to be introduced from the buffer tank to the waste liquid tank is set such that the waste liquid introduced to the waste liquid tank becomes a liquid film having a thickness equal to or less than a predetermined thickness in the waste liquid tank.

3. The waste liquid processing device according to claim 2, wherein the one-time amount of waste liquid to be introduced is set such that the energy ray of the radiation unit reaches a deep part of the liquid film when the introduced waste liquid becomes the liquid film.

4. The waste liquid processing device according to claim 1, wherein the radiation of the radiation unit is interrupted when the waste liquid is introduced from the buffer tank to the waste liquid tank, and the radiation of the radiation unit is resumed after predetermined time in which the introduced waste liquid becomes the liquid film.

5. The waste liquid processing device according to claim 1, wherein the buffer tank includes an introduction port which has a small diameter and intermittently introduces the stored waste liquid to the waste liquid tank.

6. The waste liquid processing device according to claim 1, wherein the buffer tank includes a pump which intermittently introduces the stored waste liquid to the waste liquid tank.

7. The waste liquid processing device according to claim 1, wherein the buffer tank includes a pressure chamber which collects the waste liquid to be stored, an introduction port which introduces the waste liquid from the pressure chamber to the waste liquid tank, and a pressure generating unit which intermittently generates pressure in the pressure chamber to intermittently introduce the waste liquid in the pressure chamber from the introduction port to the waste liquid tank.

8. The waste liquid processing device according to claim 1, wherein the buffer tank includes an introduction port which introduces the waste liquid at a predetermined height from the buffer tank to the waste liquid tank and a hydraulic head pressure changing unit which intermittently introduces the waste liquid in the buffer tank from the introduction port to the waste liquid tank by intermittently changing hydraulic head pressure of the waste liquid stored in the waste liquid tank with respect to the introduction port.
